(19) United States
(12) Patent Application Publication
(10) Pub. No.: US 2026/0177730 A1
(43) Pub. Date: Jun. 25, 2026

(54) FLEXIBLE RADIO-FREQUENCY-TRANSPARENT SOLAR REFLECTIVE FILM

(71) Applicant: The Hong Kong University of Science and Technology, Hong Kong (CN)

(72) Inventors: Baoling HUANG, Hong Kong (CN); Yinglun ZHANG, Hong Kong (CN)

(21) Appl. No.: 19/430,344

(22) Filed: Dec. 23, 2025

Related U.S. Application Data
(60) Provisional application No. 63/738,532, filed on Dec. 24, 2024.

(51) Int. Cl. G02B 5/20; G02B 1/04; G02B 1/14; G02B 5/28

(52) U.S. Cl. CPC G02B 5/208; G02B 1/04; G02B 1/14; G02B 5/281

(57) ABSTRACT

A RF-transparent solar reflective film includes a substrate, a near-infrared reflective layer, a glue layer, a protective layer, and an anti-scratch and abrasion-resistant layer. The near-infrared reflective layer is disposed on the substrate and comprises at least one DMD structure. Each DMD structure comprises a first dielectric layer, a second dielectric layer, and a metal layer sandwiched between the first dielectric layer and the second dielectric layer. The near-infrared reflective layer is micro-patterned to define separated metallic regions with interspatial gaps sized to interrupt electrical continuity of the metal layer and thereby enable RF signal transmission while maintaining near-infrared reflectivity. The glue layer is disposed over the near-infrared reflective layer and in contact with the substrate through the gaps. The protective layer is laminated over the glue layer. The anti-scratch and abrasion-resistant layer is disposed on a top surface of the protective layer.

### TECHNICAL FIELD

The present invention relates to optical and electromagnetic functional film technology, particularly to a flexible radio-frequency-transparent solar reflective film having a dielectric-metal-dielectric structure with micro planar patterns.

### BACKGROUND

Solar reflective films are extensively utilized in buildings and vehicles to reduce heat gain from solar irradiation by effectively reflecting near infrared radiation, which accounts for around 52% of the solar energy. However, although the thermal benefits of these films are well-documented, they also significantly attenuate radiofrequency (RF) signals, typically blocking 20-30 dB of RF transmission. This attenuation affects a range of communication technologies within the 2G to 5G cellular spectra, as well as GPS, outdoor Wi-Fi, radio, and Bluetooth systems.

In buildings, such attenuation can cause dropped calls and reduced data speeds, while in vehicles it affects GPS navigation, telematics, and emergency communication. The blockage of RF signals also reduces the reliability of outdoor Wi-Fi and other short-range wireless services, limiting user convenience and connectivity.

Existing solutions, such as installing external antennas on rooftops or vehicle bodies, can restore signal transmission but are costly, visually intrusive, and difficult to implement in many practical scenarios.

For example, several methods have been developed to mitigate the RF signal attenuation caused by solar reflective films; however, each still presents notable limitations. One method involves using external antennas or small-signal RF amplifiers to compensate for weakened wireless signals, but these require additional components, increase cost and installation complexity, and can detract from the appearance or structure of buildings and vehicles. Another method employs intelligent reflecting surfaces (IRS) that dynamically manipulate RF waves to restore communication quality, yet their dependence on active electronic components and control systems makes them expensive, difficult to scale, and sensitive to environmental factors. A further approach utilizes frequency selective surface (FSS) structures composed of periodic metallic or dielectric patterns to selectively transmit RF signals. While simpler and more cost-effective, traditional FSS-based films still struggle to maintain both optical uniformity and near-infrared reflectivity in large-area transparent applications.

Therefore, there is a need for a solar reflective thermal insulation film that is capable of effectively transmitting radio-frequency signals while maintaining a high near-infrared reflectance, so as to overcome the problem of conventional thermal insulation films blocking wireless communications, thereby satisfying the dual requirements of energy efficiency and communication reliability in building and vehicle applications.

### SUMMARY OF INVENTION

It is an objective of the present invention to provide an apparatus and a method to address the aforementioned shortcomings and unmet needs in the state of the art.

In the present invention, radio frequency-transparent (RF-transparent) reflective films are presented, providing solar control and allow uninterrupted RF signal transmission. This technology enables buildings and vehicles to maintain both solar energy insulation and wireless connectivity. The RF-transparent reflective films can be applied in various industries such as architecture, automotive, and consumer electronics, including smart windows for buildings, automotive glass, and smart home systems. These films can be integrated into residential and commercial buildings, electric vehicles, and wearable devices, offering a solution for energy efficiency and seamless communication in environments that require both thermal management and RF transparency.

In accordance with an aspect of the present invention, a RF-transparent solar reflective film is provided. The RF-transparent solar reflective film includes a substrate, a near-infrared reflective layer, a glue layer, a protective layer, and an anti-scratch and abrasion-resistant layer. The near-infrared reflective layer is disposed on the substrate and comprises at least one dielectric-metal-dielectric (DMD) structure. Each DMD structure comprises a first dielectric layer, a second dielectric layer, and a metal layer sandwiched between the first dielectric layer and the second dielectric layer. The near-infrared reflective layer is micro-patterned to define separated metallic regions with interspatial gaps sized to interrupt electrical continuity of the metal layer and thereby enable RF signal transmission while maintaining near-infrared reflectivity. The glue layer is disposed over the near-infrared reflective layer and in contact with the substrate through the gaps. The protective layer is laminated over the glue layer. The anti-scratch and abrasion-resistant layer is disposed on a top surface of the protective layer.

By the above configuration, in the present invention, critical challenges associated with conventional thermally reflective films get addressed, particularly the undesirable electromagnetic shielding effects induced by continuous metallic functional layers.

The configuration provides a solution for a solar control film that incorporates a dielectric-metal-dielectric (DMD) structure with micro planar patterns, designed to optimize both thermal reflectivity and RF transparency. The DMD structure with micro-patterned features enhances the selective near-infrared reflectance of the film, enabling efficient thermal insulation, while simultaneously allowing for the transmittance of RF signals through the film. The micro patterns are designed with feature sizes below the human visual perception threshold, thereby minimizing their impact on the visual uniformity of the film. This ensures a clear, aesthetically pleasing appearance without compromising the film's functional performance.

Additionally, the film incorporates a multi-layer protective structure, which improves the film's resistance to abrasion, aging, and corrosion. This protective layer significantly enhances the durability and service life of the film, while maintaining its optical and thermal properties over extended periods of use.

The invention thus provides a highly effective solution for advanced reflective thermal insulation films, suitable for applications requiring both RF transparency and thermal control. Notably, this solution is particularly applicable in the fields of building and automotive interiors, where effective solar control and the transmission of RF signals are essential.

### BRIEF DESCRIPTION OF DRAWINGS

Embodiments of the invention are described in more details hereinafter with reference to the drawings, in which:

FIG. 1A illustrates a front schematic view of a flexible radio-frequency-transparent solar reflective film according to some embodiments of the present invention;

FIG. 1B illustrates a cross-sectional schematic view taken along line 1B-1B′ of FIG. 1A according to some embodiments of the present invention;

FIG. 2 illustrates a schematic diagram for explaining the visual perception characteristics of the RF-transparent solar reflective film;

FIG. 3 provides a microscopic schematic view showing the structural configuration of the RF-transparent solar reflective film;

FIG. 4 provides a graph comparing the optical properties between the traditional reflective film and the solar reflective film with planar micro patterns;

FIG. 5 provides a graph exhibiting the RF-transparency of the two different optical thin films in the radio frequency range;

FIG. 6 illustrates a schematic top view of a flexible radio-frequency-transparent solar reflective film having a variable-density micro-pattern arrangement according to some embodiments of the present invention;

FIG. 7 illustrates a schematic top view of a flexible radio-frequency-transparent solar reflective film having a regionally differentiated DMD structure configuration according to some embodiments of the present invention; and

FIG. 8 illustrates a partial cross-sectional schematic view of a flexible radio-frequency-transparent solar reflective film according to some embodiments of the present invention.

### DETAILED DESCRIPTION OF THE INVENTION

In the following description, flexible radio-frequency-transparent solar reflective films and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

The present disclosure provides a solar control film that integrates a dielectric-metal-dielectric (DMD) structure with micro planar patterns to achieve both high near-infrared reflectivity for thermal insulation and high radio-frequency (RF) transmittance for wireless communication. The micro patterned metal layer is designed to interrupt the continuous conductive pathway typically responsible for electromagnetic shielding, thereby allowing RF signals to pass through the reflective film with minimal attenuation. The feature size of these micro patterns is smaller than the visual perception threshold of the human eye, preserving excellent visual uniformity and transparency. The film can be fabricated by depositing a reflective metallic coating on a substrate followed by patterning through photolithography or chemical etching, forming a dense and precisely controlled DMD structure. To further enhance durability, a multi-layer protective configuration is applied, including abrasion-resistant, anti-aging, and anti-corrosion layers, which collectively extend the film's service life while maintaining its optical and thermal performance. The resulting RF-transparent reflective film is suitable for integration in building and automotive glazing systems, providing both energy-saving solar control and seamless wireless connectivity for indoor and in-vehicle environments.

Conventional energy-saving thermal insulation films typically fall into two categories: reflective and absorptive. The reflective type commonly utilizes a metallic functional layer, whereas the absorptive type generally employs a ceramic-based structure. Notably, the absorptive film exhibits negligible shielding against radio frequency signals; however, its heat-blocking mechanism based on absorption rather than reflection can result in indirect thermal transfer and increased heating under solar exposure. In contrast, the reflective film avoids this secondary heating issue, providing superior thermal insulation and energy-saving performance. Nevertheless, the metallic functional layer of the reflective film also introduces an undesirable electromagnetic shielding effect that obstructs signal propagation. Currently, a commercial product is available that achieves selective reflection by laminating more than 200 polymer layers with different optical properties. However, the spectral selectivity of such multilayer films remains limited. In particular, the reflectance in the near-infrared band is insufficient, so that a considerable portion of solar radiation energy is still absorbed, thereby adversely affecting the thermal insulation and energy-saving performance.

In view of the foregoing, the present invention provides a solution that addresses the diminished transmittance exhibited by conventional reflective films within the radio frequency spectrum.

Reflective thermal insulation films typically feature a three-layer architecture: a substrate layer, a functional layer, and an upper protective layer. Both the substrate and protective layers are generally composed of polymeric materials, which exhibit low impedance to RF signal transmission. The functional layer, essential for the film's electromagnetic properties, typically includes a dielectric layer and a metal layer. The metal layer is typically deposited on the substrate layer by magnetron sputtering to form a dense structure. Although this structure can provide good thermal insulation and reflective performance, it also produces a significant electromagnetic shielding effect, thereby reducing the transmission capability of radio-frequency and microwave signals.

In this regard, by the provided solution of the present invention, the dielectric-metallic-dielectric (DMD) structure with micro planar patterns, achieved through specific fabrication methods, is designed to match specific RF wavelengths. By precisely tuning the spatial dimensions and periodicity of the micro patterns, the structure effectively transmits electromagnetic waves within the desired frequency range, ensuring RF transparency at those frequencies. In some embodiments, the periodic arrangement of metallic grid elements within the RF-transparent reflective film is separated by processing gaps ranging from 1 to 50 μm. These gaps disrupt the continuous conductive layer, allowing for improved RF transmission while retaining reflective properties for thermal insulation.

In some embodiment, the DMD structure employs at least one dielectric layer comprising metal oxides, nitrides, fluorides, or combinations thereof and at least one metal layer containing pure metal or metal alloy. In some embodiment, in the DMD structure, the metal oxides of the dielectric layer include aluminum oxide, silicon oxide, tin oxide, titanium dioxide, or combinations thereof; the nitrides of the dielectric layer include silicon nitride, aluminum nitride, or combinations thereof; and the fluorides nitrides of the dielectric layer include aluminum fluoride, magnesium fluoride, calcium fluoride, or combinations thereof. In some embodiments, in the DMD structure, the pure metal of the metal layer includes silver, aluminum, copper, nickel, chromium, gold, or combinations thereof; and the metal alloy of the metal layer includes silver-copper alloy, silver-magnesium alloy, and silver-indium alloy, nickel-chromium alloy and their derivative alloy through adding other elements, or combinations thereof. In some embodiments the thicknesses of the employed dielectric layers in the DMD structure are in a range from about 10 nm to about 500 nm and the thickness of the employed metal layer in the DMD structure is in a range from about 5 nm to about 30 nm.

In the context of visual comfort and safety, particularly in applications like automotive windows or residential glass, the size of these micro patterns is of critical importance. The human eye's ability to perceive fine details is governed by principles of light diffraction and the structure of the eye itself. According to the Fraunhofer diffraction law, the minimum angular resolution of the human eye can be determined by the expression 1.22×(λ/d), where d is the pupil diameter and λ is the wavelength of the incident visible light. Using a typical visible-light wavelength of 5.5×10⁻⁷ m and a pupil diameter of approximately 5×10⁻³ m for estimation, the minimum angular resolution is about 1.34×10⁻⁴ radians (approximately 0.134 mrad). At a typical viewing distance, for example, the distance between an automobile windshield and a driver's pupil (about 90 cm), the corresponding minimum resolvable object size is approximately 1.21×10⁻⁴ m, that is, about 120 micro-meters.

This characteristic is particularly important in automotive applications, where visual comfort and driving safety depend on clear, unobstructed views. The small processing gaps allow the RF-transparent film to maintain its performance in both RF transparency and solar reflectivity, while simultaneously enhancing the visual experience by ensuring that the fine details of the film's structure are not noticeable. The film thus provides a solution that combines high functionality with superior visual quality, significantly enhancing both safety and comfort in everyday use.

In addition to ensuring the thermal insulation performance and visual comfort provided by solar reflective films, it is crucial to consider the service life of the entire film. Following photolithography/chemical etching post-treatment, the outermost dielectric layer remains exposed to the air. According to some embodiments, this dielectric layer comprises metal oxides, nitrides, or fluorides. However, if this dielectric layer is compromised, the underlying metal layer (e.g., silver layer) is prone to rapid oxidation, such as forming silver oxide (Ag₂O). This oxidation significantly diminishes the film's infrared reflectivity and can lead to the formation of visible spots, detracting from the film's aesthetic quality.

In order to mitigate these risks and enhance the longevity of the solar reflective film, a multi-layer protective structure is proposed in the present invention. To ensure the stability and durability of the silver layer, a multi-layer structure is employed atop the dielectric layer. The multi-layer structure consists of three layers, arranged from top to bottom as follows: Anti-scratch and abrasion resistance layer, a protective layer, and a glue layer.

The anti-scratch and abrasion resistance layer provides a robust barrier against physical damage, thereby preventing scratches and abrasion that could compromise the metal layer. The protective layer offers additional mechanical strength and chemical resistance, acting as a secondary defense against environmental factors. The glue layer functions as an adhesive that also imparts anti-aging properties, further safeguarding the dielectric and silver layers from oxidation and corrosion. By incorporating these protection layers, the abrasion resistance, anti-aging, and anti-corrosion capabilities of the RF-transparent reflective film are significantly enhanced. The multi-layer structure significantly extends the service life of the solar reflective films while preserving its optical and thermal performance. This approach ensures the film maintains its functional and aesthetic properties even under challenging environmental conditions.

In some embodiments, the glue layer includes at least one polymer comprising acrylic resin, polyamide, epoxy resin, polyurethane, or combinations thereof, so it is referred to as a polymer glue layer. In some embodiment, the thickness of the polymer glue layer is in a range from about 10 nm to about 5000 nm, and the deposition process of the polymer glue layer includes roll coating, spray coating, spin coating, blade coating, or combinations thereof.

In some embodiments, the protective layer comprises polyethylene terephthalate (PET), which provides high optical transparency, excellent mechanical flexibility, and dimensional stability, so it is referred to as a PET protective layer. The PET protective layer also exhibits good adhesion compatibility with polymer glue layers or any dielectric coatings, as well as high resistance to moisture, ultraviolet light, and thermal deformation. In some embodiments, the thickness of the PET protective layer is in a range from about 10 μm to about 40 μm.

In some embodiments, the anti-scratch and abrasion resistance layer has the thickness in a range from about 0.1 um to about 15 um. The anti-scratch and abrasion-resistant layer comprises epoxy acrylate, polyether acrylate, trimethylolpropane triacrylate, neopentyl glycol diethyl diacrylate, barium sulfate, 2-isopropyl anthracene, or a combination thereof.

Several specific exemplary structures for the flexible radio-frequency-transparent solar reflective films are provided below to further facilitate understanding of the technical solution presented in the present invention.

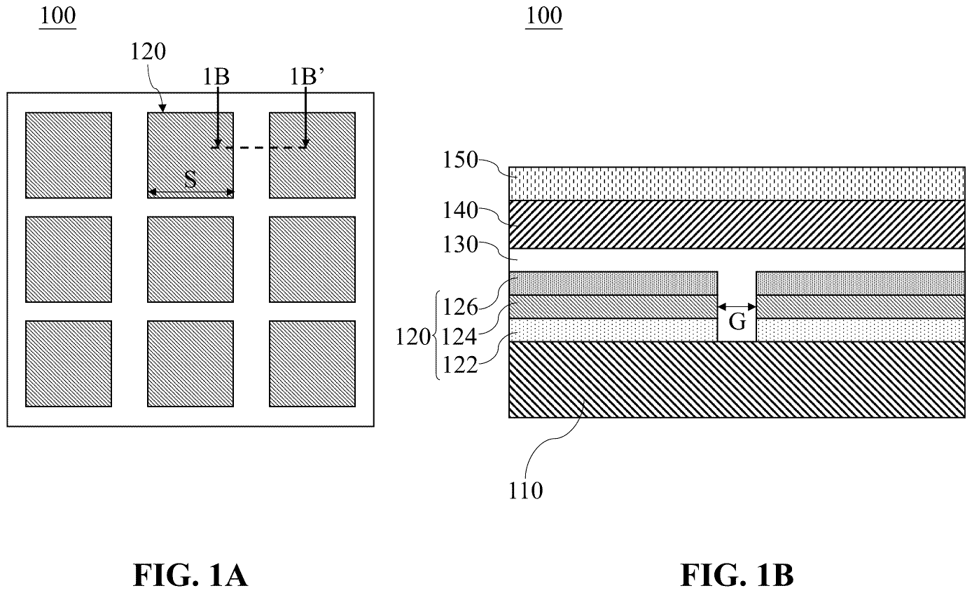

FIG. 1A illustrates a front schematic view of a flexible radio-frequency-transparent solar reflective film 100 according to some embodiments of the present invention, and FIG. 1B illustrates a cross-sectional schematic view taken along line 1B-1B′ of FIG. 1A according to some embodiments of the present invention. The flexible radio-frequency-transparent solar reflective film 100 includes a substrate 110, a near-infrared reflective layer 120, a glue layer 130, a protective layer 140, and an anti-scratch and abrasion resistance layer 150.

The substrate 110 is formed of PET that provides optical transparency, mechanical flexibility, and dimensional stability. The PET substrate 110 serves as the base support for the subsequent deposition of functional layers and exhibits low impedance to RF signal transmission, thereby facilitating RF transparency of the overall structure for the flexible radio-frequency-transparent solar reflective film 100. Accordingly, the substrate 110 can serve as or be referred to as a visible-light transparent substrate.

The near-infrared reflective layer 120 is formed and disposed on the substrate 110. The near-infrared reflective layer 120 includes a dielectric-metal-dielectric (DMD) structure comprising a first dielectric layer 122, a metal layer 124, and a second dielectric layer 126. The first dielectric layer 122 is disposed on the substrate 110 and makes contact with the substrate 110. The metal layer 124 is disposed on the first dielectric layer 122 and makes contact with the first dielectric layer 122. The second dielectric layer 126 is disposed on the metal layer 124 and makes contact with the metal layer 124, and thus the metal layer 124 is sandwiched between the first dielectric layer 122 and the second dielectric layer 126.

In some embodiments, the first dielectric layer 122 and the second dielectric layer 126 are formed of titanium dioxide (TiO₂), silicon oxide (SiO₂), aluminum oxide (Al₂O₃), or combinations thereof. In some embodiments, the metal layer 124 is formed of silver (Ag), aluminum (Al), copper (Cu), chromium (Cr), or an alloy thereof, such as silver-copper or silver-magnesium alloys. In one embodiment, the DMD structure is represented as TiO₂/Ag/TiO₂, deposited onto the substrate 110 by magnetron sputtering.

In some embodiments, the term metal layer 124 may be interchangeably referred to as a metallic layer, which is not limited to a pure metal film but may also include a layer exhibiting metallic characteristics capable of reflecting near-infrared light. For example, the metallic layer may be formed of a metal alloy, a metal-dielectric composite layer, or a doped conductive oxide layer such as indium tin oxide (ITO) or aluminum-doped zinc oxide (AZO), provided that the layer exhibits sufficient electrical conductivity and near-infrared reflectivity.

The near-infrared reflective layer 120 includes multiple DMD structures (i.e., each section of the first dielectric layer, the metal layer, and the second dielectric layer collectively forming one DMD structure) is configured to form micro planar patterns that define separated metallic regions with interspatial gaps G ranging from about 1 μm to about 50 μm. The maximum dimension S of each metallic region is in a range from about 0.5 mm to about 50 mm. The micro-patterned configuration interrupts the continuity of the metal layer 124, thereby reducing its electromagnetic shielding effect and enabling RF signal transmission while maintaining high near-infrared reflectivity for solar control. The spatial dimensions and periodicity of these patterns are selected to correspond to specific RF wavelengths, such that the flexible radio-frequency-transparent solar reflective film 100 transmits electromagnetic waves in the desired communication frequency range.

In some embodiments, each layer of the DMD structure may be subjected to a selectively patterning process, such that the first dielectric layer 122, the metal layer 124, and the second dielectric layer 126 collectively define micro planar patterns with the gap G. The selectively patterned configuration produces isolated metallic regions spaced apart by the desired gap G, interrupting the continuity of the conductive layer and allowing RF signal transmission through the near-infrared reflective layer 120. In some embodiments, the first dielectric layer 122 and the second dielectric layer 126 may be formed of different dielectric materials to adjust the effective wave reflectivity of the incident light reaching the metal layer 124. The difference in refractive indices between the upper and lower dielectric layers allows optimization of optical interference and phase matching at the interfaces. Furthermore, the thicknesses of the first dielectric layer 122 and the second dielectric layer 126 may be different (e.g., different values of the range from 10 nm to 500 nm), which serves to finely tune the effective reflectivity of the metal layer 124 for incident electromagnetic waves, thereby achieving desired spectral selectivity and optical performance.

The glue layer 130 is disposed on the near-infrared reflective layer 120. The glue layer 130 can cover the near-infrared reflective layer 120 and extend to make contact with the substrate 110 through the gap G, forming contact interfaces with the first dielectric layer 122, the metal layer 124, and the second dielectric layer 126. In this configuration, each combination of the first dielectric layer 122, the metal layer 124, and the second dielectric layer 126 forms a DMD structural block disposed on the substrate 110. Each DMD structural block has an upper surface and surrounding side edges that are entirely covered by the glue layer 130, such that the DMD structural block is completely encapsulated between the substrate 110 and the glue layer 130. This encapsulated configuration enhances mechanical stability and protects the DMD structural block from environmental exposure.

The glue layer 130 is formed of a polymer comprising acrylic resin, polyamide, epoxy resin, polyurethane, or combinations thereof, and it is also referred to as a polymer glue layer. The glue layer 130 provides surface planarization, enhances the stability of the metal layer 124, and functions as an adhesive interface for bonding with the upper protective layer. In some embodiments, the thickness of the glue layer 130 is in a range from about 10 nm to about 5000 nm, and the deposition process may include roll coating, spray coating, spin coating, or blade coating.

The protective layer 140 is disposed and laminated on the glue layer 130. The protective layer 140 can be formed using a PET material so it is also referred to as a PET protective layer 140. The protective layer 140 exhibits high optical transparency, excellent mechanical flexibility, and resistance to thermal deformation and moisture. The thickness of the protective layer 140 is in a range from about 10 μm to about 40 μm. This layer provides mechanical reinforcement to the reflective film and protects the underlying DMD structures from external stress and environmental exposure.

The top surface of the protective layer 140 is coated with the anti-scratch and abrasion-resistant layer 150. The anti-scratch and abrasion-resistant layer 150 comprises epoxy acrylate, polyether acrylate, trimethylolpropane triacrylate, neopentyl glycol diethyl diacrylate, barium sulfate, 2-isopropyl anthracene, or a combination thereof. The thickness of the anti-scratch and abrasion-resistant layer 150 is in a range from about 5 μm to about 15 μm. The anti-scratch and abrasion-resistant layer 150 improves surface hardness, prevents physical damage, and enhances the overall durability and longevity of the flexible radio-frequency-transparent solar reflective film 100.

By the above-described structure, the flexible radio-frequency-transparent solar reflective film 100 maintains selective near-infrared reflectivity for effective thermal insulation while allowing radio-frequency signals to pass through with minimal attenuation. The multilayer configuration also provides high mechanical flexibility, optical clarity, and long-term stability suitable for integration in architectural glazing and automotive window systems.

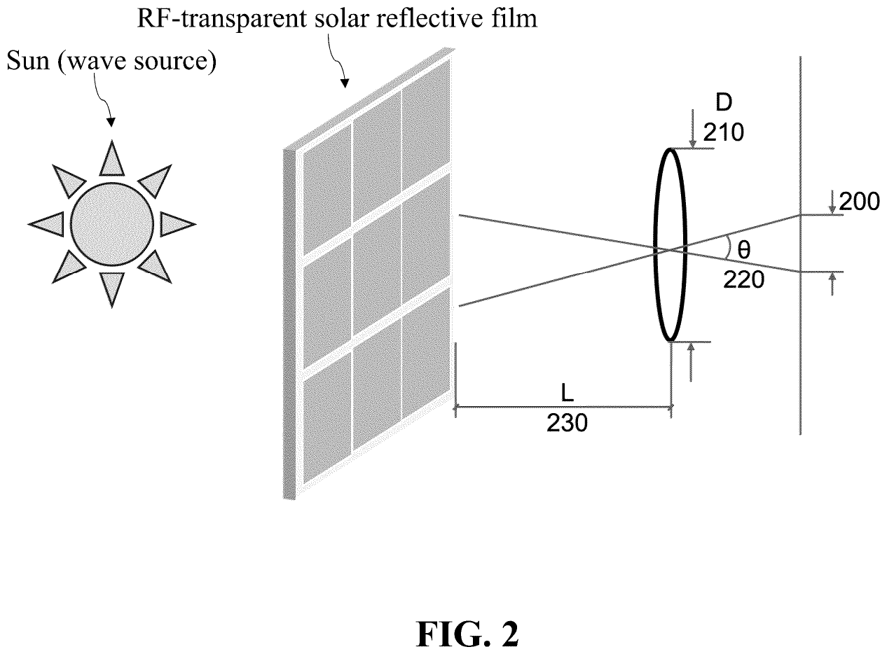

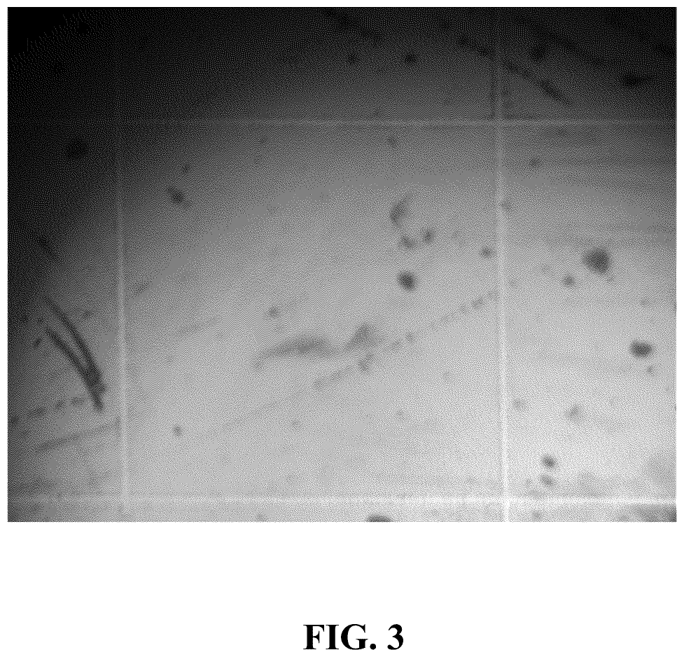

FIG. 2 illustrates a schematic diagram for explaining the visual perception characteristics of the RF-transparent solar reflective film. As shown in FIG. 2, the Sun functions as a wave source emitting visible light toward the RF-transparent solar reflective film. The light from the film is projected through an observation lens 210 that represents the optical system of the human eye. The human eye has an effective pupil diameter D, which defines the light acceptance aperture. The incident light converges at an observation distance L from the RF-transparent solar reflective film, forming a diffraction-limited spot 200 corresponding to the smallest resolvable visual detail. The angular resolution θ of the observer 220 is determined by the diffraction relationship θ=1.22×(λ/d), where λ represents the wavelength of the visible light. Accordingly, as illustrated in this schematic diagram, when the micro planar patterns of the RF-transparent solar reflective film have interspatial gaps smaller than this visual resolution threshold, the patterns become indistinguishable to the naked eye. FIG. 2 thus demonstrates that the RF-transparent solar reflective film maintains excellent visual uniformity and transparency even though its surface incorporates micro-patterned DMD structures that enable radio-frequency transmission. FIG. 3 provides a microscopic schematic view showing the structural

configuration of the RF-transparent solar reflective film. As illustrated in FIG. 3, the near-infrared reflective layer includes periodic metallic regions separated by gaps of about 10 μm, such that the metallic regions remain isolated while maintaining the film's reflective properties within the solar spectrum. To protect the metal layer from oxidation and to enhance the service life of the film, a protective PET layer is applied through a roll coating process, followed by roller pressing to achieve uniform adhesion. An additional anti-scratch and abrasion-resistant layer is formed on the outer surface to improve durability, the layer comprising epoxy acrylate, barium sulfate, and other materials, with a thickness ranging from about 5 μm to about 15 μm.

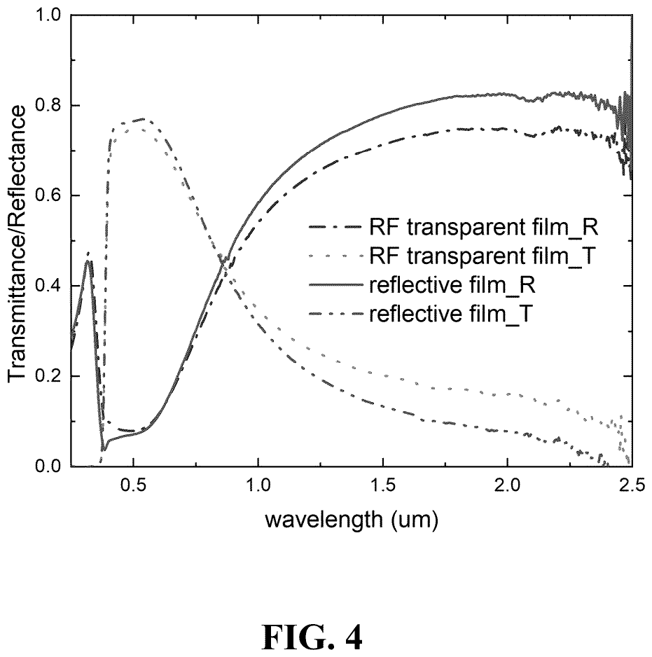

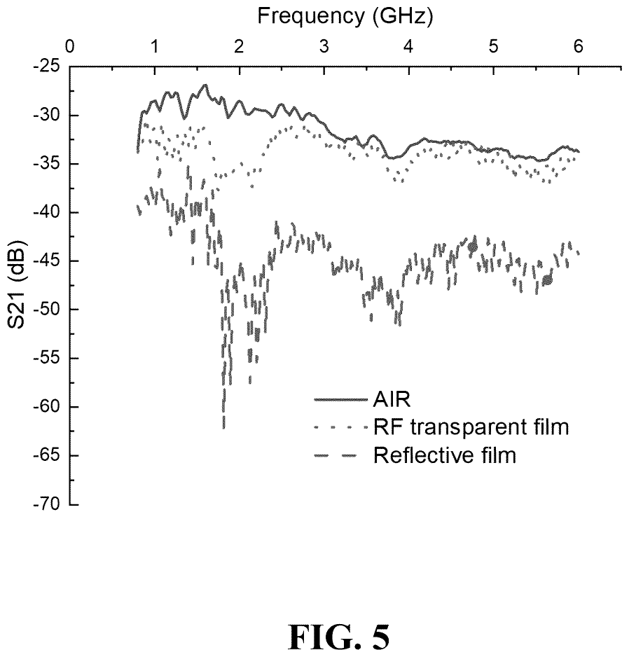

RF spectrum testing is performed to evaluate the film's RF attenuation rate by using a vector network analyzer (VNA) in the 0.8 GHz to 6 GHz range, covering mobile communication frequencies, including 2G, 3G, 4G, 5G, and Wi-Fi. The RF-transparent film demonstrated an attenuation rate of approximately 5 dB, significantly lower than the 20-25 dB attenuation observed in conventional reflective films. This indicates that the RF-transparent film allows much higher transmission of RF signals, as shown in FIG. 5, which provides a graph exhibiting the optical transparency of the two different optical thin films in the radio frequency range. UV-V is spectrum measurements are carried out using a UV-VIS-NIR spectrophotometer, revealing that the RF-transparent film reflects around 65.85% of solar radiation in the near-infrared range (780-2500 nm), compared to 69.32% for conventional films. This corresponds to about 95% of the reflectivity of conventional films. At 550 nm, the visible light transmittance of the RF-transparent film is 68.55%, slightly lower than the 70.88% of conventional films, with the difference attributed to debris contamination during processing. These optical parameters are referenced in FIG. 4, which provides a graph comparing the optical properties between the traditional reflective film and the solar reflective film with planar micro patterns, and the results demonstrate that while the RF-transparent film slightly reduces visible light transmittance, it retains most of the reflective properties of conventional films, while significantly improving RF signal transmission. The performance testing is conducted in a controlled environment using standard equipment in an RF anechoic chamber, where the film is subjected to signal attenuation measurements under controlled conditions.

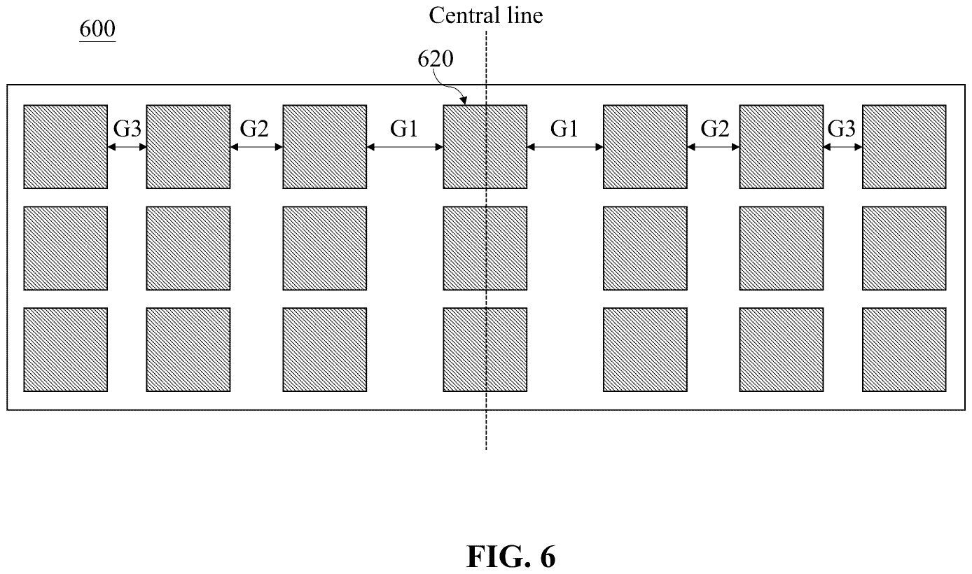

FIG. 6 illustrates a schematic top view of a flexible radio-frequency-transparent solar reflective film 600 having a variable-density micro-pattern arrangement according to some embodiments of the present invention. As shown in FIG. 6, a near-infrared reflective layer 620 with multiple DMD structures is distributed on the surface of the flexible radio-frequency-transparent solar reflective film 600 in a periodic pattern. The metallic regions of the near-infrared reflective layer 620 with multiple DMD structures are separated by multiple interspatial gaps G1, G2, and G3, which represent different pattern intervals across the flexible radio-frequency-transparent solar reflective film 600. A central line is defined at the middle of the flexible radio-frequency-transparent solar reflective film 600, serving as a symmetry reference for the layout of the micro planar patterns.

In the configuration illustrated, the spacing values satisfy the relationship G1>G2>G3, where the gaps G1, G2, and G3 are each within the range previously defined between about 1 μm and about 50 μm. This configuration forms a lateral gradient in pattern density, in which the spacing near the central line is relatively larger and gradually decreases toward the edges of the film, resulting in a denser metallic pattern in the outer region. Such a gradient pattern enhances visual comfort and optical uniformity while maintaining efficient near-infrared reflection and improved radio-frequency transparency in the central region.

Although FIG. 6 illustrates a configuration in which the gaps G1, G2, G3 vary between adjacent micro planar patterns, other modifications are also possible. In some embodiments, the micro planar patterns may be grouped into multiple pattern groups, such as a first group, a second group, and a third group, arranged from the central region toward the edges of the flexible radio-frequency-transparent solar reflective film. Each group includes multiple metallic pattern units having a uniform gap within the same group, while the gap differs between groups to form a stepped density gradient across the flexible radio-frequency-transparent solar reflective film. This group-based configuration achieves similar effects in controlling visual uniformity and RF transmission while simplifying the patterning process.

In other embodiments, the same gap-variation principle may also be applied in the vertical direction of the flexible radio-frequency-transparent solar reflective film, or simultaneously in both lateral and vertical directions, thereby forming a two-dimensional gradient distribution of the micro planar patterns. Such a variable-density configuration enables optimization between visual transparency, RF transparency, and solar reflectivity according to the installation orientation and optical requirements of architectural or automotive applications.

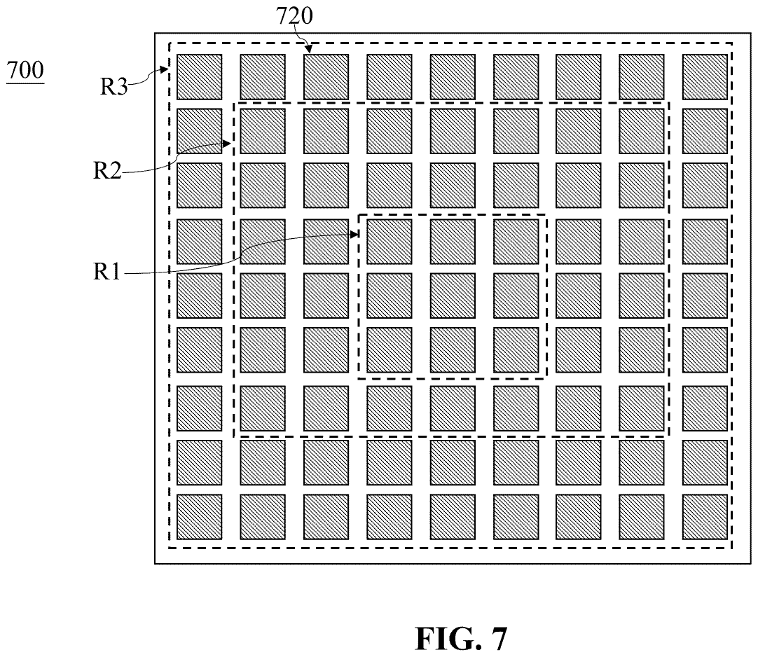

FIG. 7 illustrates a schematic top view of a flexible radio-frequency-transparent solar reflective film 700 having a regionally differentiated DMD structure configuration according to some embodiments of the present invention. As shown in FIG. 7, the near-infrared reflective layer 720 includes a plurality of DMD structures arranged in a two-dimensional periodic pattern, which are divided radially from the center into multiple regions, including a central region R1, an intermediate region R2, and an outer region R3. The boundaries of these regions are indicated by dashed lines in FIG. 7.

Within each region R1-R3, the DMD structures may have identical physical parameters, while the DMD structures in different regions have different physical parameters.

The physical parameters may include, for example, the interspatial gap (i.e., the gap G) between the adjacent DMD structures or the thickness of the metal layer within each DMD structure. In one embodiment, the interspatial gap gradually decreases from the central region R1 to the outer region R3, such that the gap in the region R1>the gap in the region R2>the gap in the region R3, forming a radially increasing pattern density similar to that described in FIG. 6.

Alternatively, the variation in physical parameters may be implemented by adjusting thickness of the metal layer of the DMD structures across the regions. For example, the metal layer (e.g., the metal layer 124) in the central region R1 is thinner than that in the intermediate region R2, which in turn is thinner than that in the outer region R3, satisfying the relationship the thickness of the metal layer in the region R1<the thickness of the metal layer in the region R2<the thickness of the metal layer in the region R3. This “center-thin to edge-thick” thickness gradient provides improved near-infrared reflection at the outer region while maintaining higher radio-frequency transmittance and better visual transparency in the central field of view.

Such a regionally differentiated configuration allows simultaneous optimization of optical uniformity, RF transmission efficiency, and thermal insulation performance. It can also be tailored according to installation requirements by adjusting the number of regions or by applying similar gradients along different directions of the flexible radio-frequency-transparent solar reflective film 700.

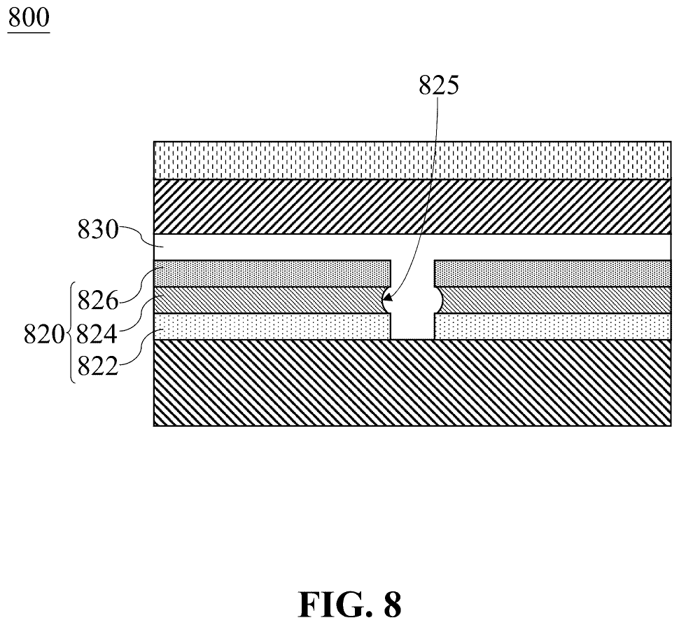

FIG. 8 illustrates a partial cross-sectional schematic view of a flexible radio-frequency-transparent solar reflective film 800 according to some embodiments of the present invention. An undercut groove 825 is introduced into the near-infrared reflective layer 820 with the DMD structures to enhance the adhesion and mechanical reliability of the DMD structure. Specifically, the near-infrared reflective layer 820 with the DMD structure includes a first dielectric layer 822, a metal layer 824, and a second dielectric layer 826, in which the metal layer 824 is disposed between the first dielectric layer 822 and the second dielectric layer 826. The near-infrared reflective layer 820 is covered by a glue layer 830 that encapsulates and fixes the DMD structure in position.

The undercut groove 825 is located at the edge of the metal layer 824 and extends along the edge of the metal layer 824. The undercut groove 825 has a concave profile resembling an inverted trapezoid or undercut cavity, providing a mechanical anchoring site for the glue layer 830. When the glue layer 830 fills the undercut groove 825, it forms an interlocking contact that distributes mechanical stress uniformly on the metal layer 824 (as the opposite edges of the metal layer 824 are shaped with the undercut groove 825). This configuration prevents peeling or delamination of the metal layer 824 under thermal expansion, mechanical bending, or aging, thereby improving the overall durability of the flexible radio-frequency-transparent solar reflective film 800 while maintaining its optical and RF transparency.

To form the structure shown in FIG. 8, the near-infrared reflective layer 820 is first deposited in a continuous manner on a substrate to create a complete unpatterned DMD structure. Selective etching is then performed sequentially from the second dielectric layer 826 downward through the metal layer 824 to the first dielectric layer 822. The second dielectric layer 826 is initially patterned by a photolithographic process to define the desired micro planar pattern and subsequently serves as an etching mask for the metal layer 824. During this step, the etching duration is intentionally extended to induce partial lateral etching within the metal layer 824, thereby forming the undercut groove 825 beneath the dielectric edge. The process continues to pattern the first dielectric layer 822, completing the definition of the DMD structure. Finally, the glue layer 830 is applied by a coating process, filling the undercut groove 825 and encapsulating the DMD pattern to stabilize the entire near-infrared reflective layer 820.

In some embodiments, the technical solution proposed in the present invention provides a highly flexible structural foundation that allows adaptive configuration according to specific usage requirements or application scenarios. Such flexibility enables modifications or design variations as illustrated in FIGS. 6 to 8, including: (1) clarified stack and material scope as well as pattern dimensions; (2) variable-density or regionally differentiated configurations; and (3) undercut-groove structures that enhance adhesion and mechanical reliability. These structural variations can be implemented individually within a single film architecture, or in combination with one another to achieve optimized optical, thermal, and radio-frequency performance depending on the intended application.

Spatial references such as “on,” “above,” “below,” and similar terms are defined relative to a component or plane as shown in the figure. These terms are for illustration only and do not limit the actual arrangement, provided the described embodiments retain their intended benefits.

It should be noted that while various structures are depicted as approximately rectangular in the illustrations, their actual shapes may differ in practice due to fabrication conditions. These shapes may include curves, rounded edges, or variations in thickness. The use of straight lines and right angles in the figures is merely a representational convenience for depicting layers and features.

In this disclosure, the terms “a,” “an,” and “the” should be interpreted to include both singular and plural forms unless explicitly specified otherwise by the context. Additionally, when describing embodiments, a component positioned “on” or “over” another component can refer to cases where the two components are directly in contact or where one or more intermediate components are situated between them.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A radio-frequency-transparent (RF-transparent) solar reflective film, comprising:
a visible-light transparent substrate;
a near-infrared reflective layer disposed on the visible-light transparent substrate and comprising at least one dielectric-metal-dielectric (DMD) structure, wherein each DMD structure comprises a first dielectric layer, a second dielectric layer, and a metal layer sandwiched between the first dielectric layer and the second dielectric layer, and wherein the near-infrared reflective layer is micro-patterned to define separated metallic regions with interspatial gaps sized to interrupt electrical continuity of the metal layer and thereby enable RF signal transmission while maintaining near-infrared reflectivity;
a glue layer disposed over the near-infrared reflective layer and in contact with the visible-light transparent substrate through the gaps;
a protective layer laminated over the glue layer; and
an anti-scratch and abrasion-resistant layer disposed on a top surface of the protective layer.

2. The RF-transparent solar reflective film according to claim 1, wherein the interspatial gaps are in a range from 1 μm to 50 μm.

3. The RF-transparent solar reflective film according to claim 2, wherein a maximum dimension of each of the metallic region is in a range from 0.5 mm to 50 mm.

4. The RF-transparent solar reflective film according to claim 3, wherein the metal layer comprises silver (Ag), aluminum (Al), copper (Cu), chromium (Cr), or an alloy thereof.

5. The RF-transparent solar reflective film according to claim 1, wherein the first dielectric layer or the second dielectric layer comprises titanium dioxide (TiO₂), silicon oxide (SiO₂), aluminum oxide (Al₂O₃), or combinations thereof.

6. The RF-transparent solar reflective film according to claim 1, wherein the glue layer makes contact interfaces with the first dielectric layer, the metal layer, and the second dielectric layer.

7. The RF-transparent solar reflective film according to claim 6, wherein the glue layer comprises a polymer selected from acrylic resin, polyamide, epoxy resin, polyurethane, or combinations thereof, and wherein the glue layer has a thickness from 10 nm to 5000 nm.

8. The RF-transparent solar reflective film according to claim 7, wherein the protective layer comprises polyethylene terephthalate (PET) having a thickness from 10 μm to 40 μm.

9. The RF-transparent solar reflective film according to claim 8, wherein the anti-scratch and abrasion-resistant layer comprises epoxy acrylate, polyether acrylate, trimethylolpropane triacrylate, neopentyl glycol diethyl diacrylate, barium sulfate, 2-isopropyl anthracene, or combinations thereof, and wherein the anti-scratch and abrasion-resistant layer has a thickness from about 5 μm to about 15 μm.

10. The RF-transparent solar reflective film according to claim 1, wherein the spacing between the metallic regions is larger proximate a central line of the RF-transparent solar reflective film and decreases toward lateral edges of the RF-transparent solar reflective film, thereby yielding a denser metallic pattern at the outer region.

11. The RF-transparent solar reflective film according to claim 10, wherein the near-infrared reflective layer comprises the micro-patterned DMD structures arranged with a lateral density gradient across a central line of the RF-transparent solar reflective film, such that the interspatial gaps G1, G2, and G3, each having a spacing value within a range from 1 μm to 50 μm, satisfy G1>G2>G3 in order from the central line toward an edge of the RF-transparent solar reflective film.

12. The RF-transparent solar reflective film according to claim 1, wherein the near-infrared reflective layer comprises the micro-patterned DMD structures organized into pattern groups arranged from a central region toward an edge of the RF-transparent solar reflective film, and wherein each of the pattern groups comprises multiple pattern units having a uniform gap within the same pattern group and different gaps between the pattern groups, thereby forming a stepped density gradient.

13. The RF-transparent solar reflective film of claim 1, wherein a gradient in the interspatial gaps is formed along a vertical direction of the RF-transparent solar reflective film or along both lateral and vertical directions of the RF-transparent solar reflective film, thereby forming a two-dimensional gradient distribution of micro planar patterns.

14. The RF-transparent solar reflective film of claim 1, wherein the near-infrared reflective layer is divided radially from a center toward an edge of the RF-transparent solar reflective film into multiple regions including a central region, an intermediate region, and an outer region, and wherein the DMD structures within each of the central, intermediate, and outer regions have identical physical parameters, while the DMD structures in different ones of the central, intermediate, and outer regions have different physical parameters.

15. The RF-transparent solar reflective film of claim 14, wherein the interspatial gap in the central region is greater than the interspatial gap in the intermediate region, and the interspatial gap in the intermediate region is greater than the interspatial gap in the outer region, thereby forming a radially increasing pattern density from the center toward the outer region.

16. The RF-transparent solar reflective film of claim 1, wherein the near-infrared reflective layer has an undercut groove located at an edge of the metal layer and extending along a periphery of the metal layer, and the undercut groove has a concave profile resembling an inverted trapezoid or undercut cavity.

17. The RF-transparent solar reflective film of claim 16, wherein the glue layer fills the undercut groove to form an interlocking contact that distributes mechanical stress and reduces peeling or delamination for the metal layer.

18. The RF-transparent solar reflective film of claim 1, wherein the first dielectric layer and the second dielectric layer are formed of different dielectric materials to adjust an effective reflectivity for incident light reaching the metal layer.

19. The RF-transparent solar reflective film of claim 1, wherein the first dielectric layer and the second dielectric layer have different thicknesses, thereby tuning an effective reflectivity of the metal layer for incident electromagnetic waves.

20. The RF-transparent solar reflective film of claim 1, wherein the first dielectric layer, the metal layer, and the second dielectric layer forms a DMD structural block disposed on the visible-light transparent substrate, and wherein the DMD structural block has an upper surface and surrounding side edges entirely covered by the glue layer, such that the DMD structural block is completely encapsulated between the visible-light transparent substrate and the glue layer.
